(19) United States
(12) Patent Application Publication
(10) Pub. No.: US 2019/0007874 A1
(43) Pub. Date: Jan. 3, 2019

(54) Method and Apparatus for Cell Reselection in a Wireless Communication System

(71) Applicant: Telefonaktiebolaget LM Ericsson (publ), Stockholm (SE)

(72) Inventors: Gunnar Mildh, Sollentuna (SE); Rui Fan, Beijing (CN)

(21) Appl. No.: 15/741,352

(22) PCT Filed: Dec. 13, 2017
(86) PCT No.: PCT/SE2017/051259

§ 371 Date: Jan. 2, 2018

(30) Foreign Application Priority Data
Jan. 5, 2017 (CN) PCT/CN2017/070269

(51) Int. Cl. H04W 36/08; H04W 36/14; H04W 76/19; H04W 76/27; H04W 36/36

(52) U.S. Cl. CPC H04W 36/08; H04W 36/14; H04W 84/042; H04W 76/27; H04W 36/36; H04W 76/19

(57) ABSTRACT

Embodiments of the present disclosure provide methods, apparatuses and computer program for cell reselection in a wireless communication system. A method implemented in a terminal device operating in a first cell and connected to a first CN comprises: in response to a re-selection of a second cell, determining whether the second cell supports the first CN; in response to determining that the first CN is supported by the second cell, establishing a connection with second cell via a first procedure; and in response to determining that the first CN is non-supported by the second cell, establishing a connection with second cell via a second procedure different from the first procedure. According to the various aspects and embodiments as mentioned above, connection of a terminal device may be restored in a fast way.

### TECHNICAL FIELD

The non-limiting and example embodiments of the present disclosure generally relate to a technical field of wireless communication, and specifically to methods, apparatuses and computer programs for cell reselection in a wireless communication system.

### BACKGROUND

This section introduces aspects that may facilitate a better understanding of the disclosure. Accordingly, the statements of this section are to be read in this light and are not to be understood as admissions about what is in the prior art or what is not in the prior art.

Currently a new fifth generation (5G) radio access technique (RAT) called New Radio (NR) is being studied in the third generation partnership project (3GPP) aiming at providing enhanced mobile broadband (eMBB) communication, massive machine type (MTC) communications, and ultra reliable and low latency communications (URLLC). It has been agreed in 3GPP to define a new Next Generation Core network (NG CN, also referred to as 5G CN) to support the NR. In addition, a tight interworking between the fourth generation (4G) Long Term Evolution (LTE) and the 5G NR is desired.

The introduction of new RAT and new CN brings challenges to mobility of terminal devices.

### SUMMARY

The introduction of new RAT and new CN brings challenges to mobility of terminal devices. In order to solve at least part of problems existing in conventional solutions for mobility of terminal devices, methods, apparatuses and computer programs are provided in the present disclosure. It can be appreciated that embodiments of the present disclosure are not limited to a NR wireless communication system, but could be more widely applied to any application scenario where similar problems exist.

Various embodiments of the present disclosure mainly aim at providing methods, apparatuses and computer programs for cell reselection in a wireless communication system. Other features and advantages of embodiments of the present disclosure will also be understood from the following description of specific embodiments when read in conjunction with the accompanying drawings, which illustrate, by way of example, the principles of embodiments of the present disclosure.

In a first aspect of the disclosure, there is provided a method implemented at a terminal device. The method includes: determining whether a second cell supports the first CN in response to a re-selection of the second cell; establishing a connection with second cell via a first procedure in response to determining that the first CN is supported by the second cell; and establishing a connection with second cell via a second procedure different from the first procedure in response to determining that the first CN is non-supported by the second cell.

In an embodiment, the first procedure may allow the second cell to reuse context of the terminal device in the first cell without contacting the first CN. In another embodiment, the first procedure may include: a RRC connection resume procedure, if the terminal device is in a RRC inactive state in the first cell; or a RRC connection re-establishment procedure, if the terminal device is in a RRC connected state and encounters a radio link failure in the first cell. In still another embodiment, the second procedure may include a RRC connection setup procedure.

In some embodiments, the terminal device may determine whether the second cell support the first CN by detecting information broadcasted by the second cell. In an embodiment, the information broadcasted by the second cell may include at least one of a type of the second cell; a CN supported by the second cell, and an indication on capability of supporting the first CN.

In an embodiment, the first CN may include one of: an evolved packet core network, EPC, and a fifth generation core network, 5G CN.

In another embodiment, the first cell may include a NR cell, and the second cell includes a LTE cell. In still another embodiment, the first cell may include a LTE cell, and the second cell may include a NR cell.

In an embodiment, the terminal device may establish a connection with the second cell by one of: establishing the connection with the second cell upon the re-selection of the second cell; establishing the connection with the second cell in response to uplink data arrival of the terminal device, and establishing the connection with the second cell in response to receiving a paging message in the downlink from the first cell.

In some embodiments, the method may further include discarding a RAN context of the first cell in response to determining that the first CN is non-supported by the second cell.

In a second aspect of the disclosure, there is provided a method implemented at a first network device. The method includes: transmitting, to a terminal device, information on a CN being supported by the first network device; receiving a context retrieval request from a second network device which receives one of a RRC connection resume request and a RRC connection re-establishment request from the terminal device; and transmitting context of the terminal device to the second network device in response to the received context retrieval request.

In one embodiment, transmitting to a terminal device information on a CN being supported by the first network device may include transmitting at least one of the following to the terminal device: a type of the first network device, the type of the first network device being associated with the CN, an identity of the CN to the terminal device, and an indication on capability of supporting the CN.

In a third aspect of the disclosure, there is provided a method implemented at a second network device. The method includes: transmitting, to a terminal device, information on a core network, CN, being supported by the second network device; receiving a connection request from the terminal device, the connection request including one of a RRC connection resume request and a RRC connection re-establishment request; retrieving context of the terminal device from a first network device serving the terminal device in response to the received connection request; and performing one of a RRC connection resume procedure and a RRC connection re-establishment procedure with the terminal device using the retrieved context of the terminal based on the received connection request.

In an embodiment, transmitting to a terminal device information on a CN being supported by the second network device may comprise transmitting at least one of the following to the terminal device: a type of the second network device, the type of the second network device being associated with the CN, an identity of the CN to the terminal device, and an indication on capability of supporting the CN.

In another embodiment, the second network device may retrieve context of the terminal device from a first network device by: transmitting a context retrieval request to the first network device; and receiving context of the terminal device from the first network device.

In a fourth aspect of the disclosure, there is provided a terminal device. The terminal device includes a determining unit, configured to determine whether a second cell supports the first CN in response to a re-selection of a second cell; and a connecting unit, configured to establish a connection with second cell via a first procedure in response to determining that the first CN is supported by the second cell; or establish a connection with second cell via a second procedure different from the first procedure in response to determining that the first CN is non-supported by the second cell.

In a fifth aspect of the disclosure, there is provided a first network device. The first network device includes a first transmitting unit, configured to transmit, to a terminal device, information on a CN being supported by the first network device; a receiving unit, configured to receive a context retrieval request from a second network device which receives one of a RRC connection resume request and a RRC connection re-establishment request from the terminal device; and a second transmitting unit, configured to transmit context of the terminal device to the second network device in response to the received context retrieval request.

In a sixth aspect of the disclosure, there is provided a second network device. The second network device includes a transmitting unit, configured to transmit, to a terminal device, information on a CN being supported by the second network device; a receiving unit, configured to receive a connection request from the terminal device, the connection request including one of a RRC connection resume request and a RRC connection re-establishment request; a context retrieving unit, configured to retrieve context of the terminal device from a first network device serving the terminal device in response to the received connection request; and a connecting restoring unit, configured to perform one of a RRC connection resume procedure and a RRC connection re-establishment procedure with the terminal device using the retrieved context of the terminal based on the received connection request.

In a seventh aspect of the disclosure, there is provided a terminal device. The terminal device includes a processor and a memory, said memory containing instructions executable by said processor, and said processor being configured to cause the terminal device to perform a method according the first aspect of the present disclosure.

In an eighth aspect of the disclosure, there is provided a first network device. The first network device includes a processor and a memory, said memory containing instructions executable by said processor and said processor being configured to cause the first network device to perform a method according the second aspect of the present disclosure.

In a ninth aspect of the disclosure, there is provided a second network device. The second network device includes a processor and a memory, said memory containing instructions executable by said processor and said processor being configured to cause the first network device to perform a method according the third aspect of the present disclosure.

In a tenth aspect of the disclosure, there is provided a terminal device. The terminal device comprises processing means adapted to perform a method according the first aspect of the present disclosure.

In an eleventh aspect of the disclosure, there is provided a first network device. The first network device comprises processing means adapted to perform a method according the second aspect of the present disclosure.

In a twelfth aspect of the disclosure, there is provided a second network device. The second network device comprises processing means adapted to perform a method according the third aspect of the present disclosure.

In a thirteenth aspect of the disclosure, there is provided a computer program, comprising instructions which, when executed on one or more processors, cause the one or more processors to carry out a method according to the first aspect of the present disclosure.

In a fourteenth aspect of the disclosure, there is provided a computer program, comprising instructions which, when executed on one or more processors, cause the one or more processors to carry out a method according to the second aspect of the present disclosure.

In a fifteenth aspect of the disclosure, there is provided a computer program, comprising instructions which, when executed on one or more processors, cause the one or more processors to carry out a method according to the third aspect of the present disclosure.

According to the various aspects and embodiments as mentioned above, connection of a terminal device may be restored in a fast way. In an embodiment, signaling overhead required for restoring a connection of a terminal device may be reduced, and latency for the connection restoration may be reduced.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an example wireless communication network 100 in which embodiments of the disclosure may be implemented;

FIGS. 2A-2C illustrate examples of high level architecture of a wireless communication network in which embodiments of the disclosure may be implemented;

FIG. 3 illustrates possible states transitions of a terminal device;

FIGS. 4A-4E illustrates procedures for managing connections of a terminal device;

FIG. 5 illustrate a flowchart of a method implemented at a terminal device according to an embodiment of the present disclosure;

FIG. 6 illustrates a flowchart of a method implemented at a first network device according to an embodiment of the present disclosure;

FIG. 7 illustrates a signaling chart according to an embodiment of the present disclosure;

FIGS. 8A-8B illustrate flowcharts of a method implemented at a second network device according to an embodiment of the present disclosure;

FIG. 9 illustrates a schematic block diagram of an apparatus implemented as/in a terminal device according to an embodiment of the present disclosure;

FIG. 10 illustrates a schematic block diagram of an apparatus implemented as/in a first network device according to an embodiment of the present disclosure;

FIG. 11 illustrates a schematic block diagram of an apparatus implemented as/in a second network device according to an embodiment of the present disclosure; and

FIG. 12 illustrates a simplified block diagram of an apparatus that may be embodied as/in a network device, and an apparatus that may be embodied as/in a terminal device.

### DETAILED DESCRIPTION

Hereinafter, the principle and spirit of the present disclosure will be described with reference to illustrative embodiments. It should be understood, all these embodiments are given merely for one skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

As used herein, the term “wireless communication network” refers to a network following any suitable wireless communication standards, such as NR, LTE-Advanced (LTE-A), LTE, Wideband Code Division Multiple Access (WCDMA), High-Speed Packet Access (HSPA), CDMA2000, and so on. Furthermore, the communications between network devices, and, between a network device and a terminal device in the wireless communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, the NR communication protocols, and/or any other protocols either currently known or to be developed in the future.

As used herein, the term “network device” refers to a device in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a NR BS or a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that can access a wireless communication network and receive services therefrom. By way of example and not limitation, a terminal device may be referred to as user equipment (UE), a Subscriber Station (SS), a Portable Subscriber Station, a Mobile Station (MS), or an Access Terminal (AT). The terminal device may include, but not limited to, a mobile phone, a cellular phone, a smart phone, a tablet, a wearable device, a personal digital assistant (PDA), portable computers, image capture terminal devices such as digital cameras, gaming terminal devices, music storage and playback appliances, wearable terminal devices, vehicle-mounted wireless terminal devices and the like. In the following description, the terms “terminal device”, “terminal”, “user equipment” and “UE” may be used interchangeably.

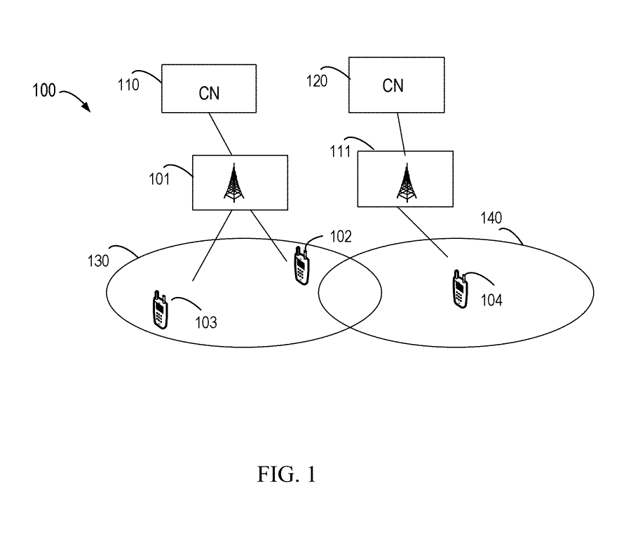

FIG. 1 illustrates an example wireless communication network 100 in which embodiments of the disclosure may be implemented. As shown in FIG. 1, the wireless communication network 100 may include one or more network devices, for example network devices 101 and 111, which may be in a form of an eNB or gNB. It will be appreciated that the network device 101 or 111 could also be in a form of a Node B, Base Transceiver Station (BTS), and/or Base Station Subsystem (BSS), AP and the like, and the network device 101 and 111 may be in different forms. The network device 101 may provide radio connectivity to a set of terminal devices (for example UEs 102 and 103) within a cell 130, while the network device 111 may provide radio connectivity to another set of terminal devices for example UE 104 in another cell 140 shown in FIG. 1.

It may be suitable to note that while in the present disclosure the term cell is sometimes used as a proxy for the network device 101 and 111 providing the radio connectivity within a cell. Thus, occasionally the disclosure may portray that ‘the cell’ provides certain functionality, however it is clear that it is in fact the network device or node that provide that functionality in the cell coverage area. Obviously, a cell may comprise certain characteristics, such as being an LTE or an NR cell as well as many other specific characteristics. Throughout this disclosure it may be convenient to describe the cell to provide these characteristics and other functionality, while in truth it is the arrangements and specifics of the network device that determine the function and characteristics of a particular cell.

A downlink (DL) transmission herein refers to a transmission from the network device to a terminal device, and an uplink (UL) transmission refers to a transmission in an opposite direction. As shown in FIG. 1, the network devices 101 and 111 connect to a core network (CN) 110 and a CN 120, respectively. For example, the network device 101 may be a 5G gNB connected to a 5G CN 110, and the network device 111 may be a LTE eNB connected to a 4G evolved packet core (EPC) 120. It has been agreed in 3GPP that LTE eNBs should also connect to the 5G-CN in order to provide 5G services for UEs connected to LTE. That is, the network device 111 may also connect to a 5G CN 110. In a deployment, the network device 101 and the network device may connect to a same CN.

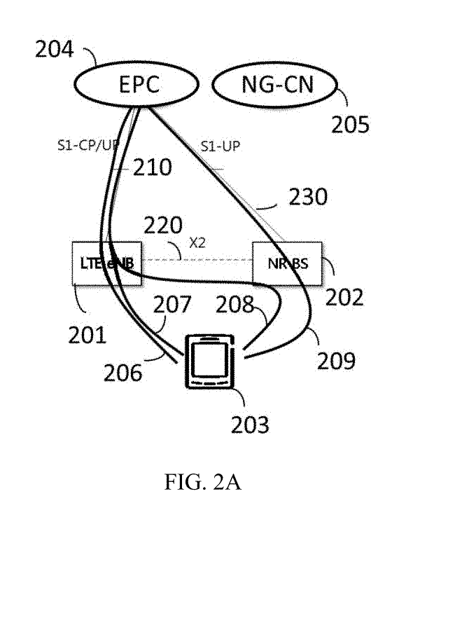

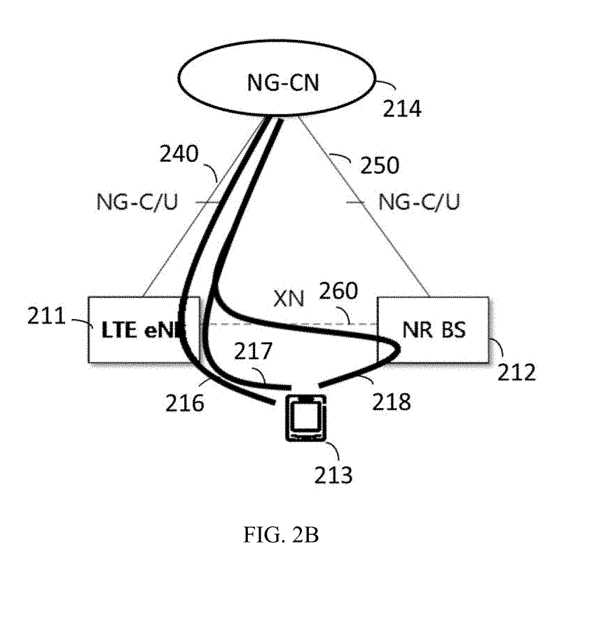

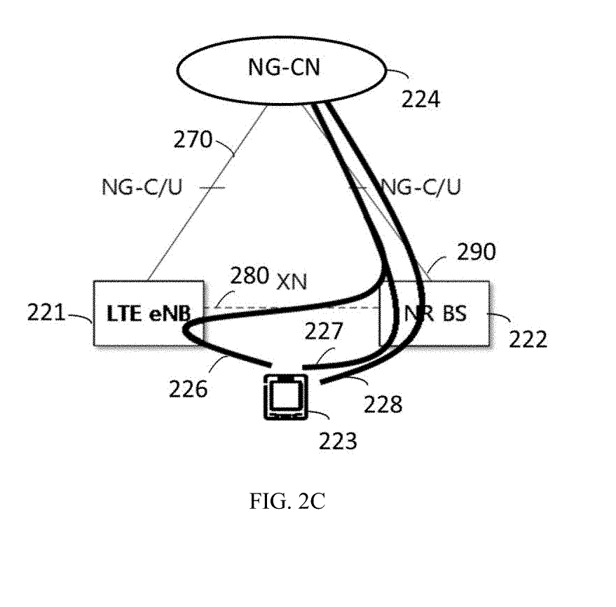

Examples of some high level architecture for connecting a RAN network device such as an eNB or a NR NB (also referred to as gNB) to a CN such as an EPC or an NG/5G CN are illustrated in FIGS. 2A-2C. In FIG. 2A, an LTE eNB 201 connects in CP and UP to an EPC 204 via a S1-CP/UP interface 210. The NR BS 202 connects to the EPC 201 via a S1-UP interface 230, and may connect to the LTE eNB 201 via an X2 interface 220. UE 203 may connect in CP via link 206 to the EPC 204, and connect in UP via one or more of link 207, 208 and 209 to the EPC. In FIG. 2B, an LTE eNB 211 connects in CP and UP to an NG-CN 214 via a NG-C/U interface 240. The NR BS 212 connects to the NG-CN 214 via a NG-C/U interface 250, and may connects to the LTE eNB 211 via an XN interface 260. UE 213 may connect in CP via link 216 to the NG-CN 214, and connect in UP via one or more of link 217 and 218 to the NG-CN. In FIG. 2C, an LTE eNB 221 connects in CP and UP to an NG-CN 224 via a NG-C/U interface 270. The NR BS 222 connects to the NG-CN 224 via a NG-C/U interface 290, and may connects to the LTE eNB 221 via an XN interface 280. UE 223 may connect in CP via link 228 to the NG-CN 224, and connect in UP via one or more of link 226 and 227 to the NG-CN. The following has been observed by inventors of the present disclosure from the example architectures shown in FIGS. 2A-2C:
An LTE eNB can be connected to both an EPC and a 5G CN in both a Control Plane (CP) and a User Plane (UP). For example, the eNB 201 in FIG. 2A may be connected to the EPC 204 via an S1-CP/UP interface 210. The eNB 211 may connect to the NG CN 214 via a NG-C/U interface 240. The eNB 221 may connect to the NG CN 224 via a NG-C/U interface 270.
An NR BS can be connected in both CP and UP to a 5G CN, and can also be connected in UP to an EPC. For example, the NR BS 202 is connected to the EPC 204 via an S1-UP interface 230, while the NR BS 212 is connected to the NG CN 214 via an NG-C/U interface 250.
The solution supports Dual Connectivity (DC) where the UE is connected to two BSs at the same time and UP data can be send via both BSs. For example, the UE 203 are connected to both the LTE eNB 201 and the NR BS 202, and UP data may be sent via a link 207 or 208 though the LTE eNB 201 and a link 209 though the NR BS 202.
UE configured with DC may be “anchored” in one master RAT (LTE or NR) responsible for managing CP connections, handling mobility, and controlling initial access etc. For example, the UE 213 in FIG. 2B has a dual connectivity with the LTE eNB 211 and the NR NB 212, and is anchored in the LTE eNB 211, while the UE 223 in FIG. 2C is anchored in the NR BS 222. DC is only applied to UEs in RRC_CONNECTED state. A UE in sleep states (e.g. RRC_IDLE, RRC_INACTIVE) is mainly connected to a master RAT.
Since an LTE eNB supports CP connections to both an EPC and a 5G CN, it can act as a master network device for UEs attached to the EPC or the 5G-CN.
Which CN a UE should attach to is usually determined at initial power on of the UE. UEs powering on in a NR cell can only attach to a 5G-CN, while UEs powering on in a LTE cell may choose whether to attach to an EPC or a 5G-CN. It is proposed by inventor of the present disclosure that an LTE eNB may broadcast its capability for supporting the 5G-CN to UEs and the UE choosing to attach to the 5G-CN may indicate its choice in an initial signaling message to the LTE eNB, so that the LTE eNB can route the signaling message to the 5G-CN.

Typically, a UE may stay in a same CN as long as there is coverage of the CN. If a network is not fully covered by the 5G-CN, there may be a need for a UE to transit from one CN to another in some cases, two examples of which are listed below:
the UE is connected to a 5G CN but enters an area where only an EPC is supported;
the UE is connected to an EPC but wants to switch to an NR radio (not using DC), and as a result, the UE has to be moved to a 5G CN.

Depending of state of the UE, procedures for supporting mobility of the UE may vary. Inventors of the present disclosure have envisaged the following possible states for UEs connected to NR or LTE and the 5G-CN:
RRC_CONNECTED: A UE in RRC_CONNECTED state has a RRC connection to a RAN and a corresponding S1 connection to a CN. Context (such as identity, location, bearer, data rate, configurations on encryption, and QoS, etc.) of the UE is available in both the CN and the RAN. Mobility of the UE is controlled by the network (NW), and the UE can transmit/receive user data to/from NW.
RRC_INACTIVE: a UE in a RRC_INACTIVE state does not have a RRC connection to the RAN, but a corresponding S1 connection from the UE to a CN remains. In addition, context of the UE is available in both the CN and the RAN. Mobility of the UE is controlled by the UE itself. The UE may update its location to the RAN/CN with a granularity of tracking area. In the RRC_INACTIVE state, the UE may not send/receive user data to/from NW directly.
RRC_IDLE: a UE in a RRC_IDLE state does not have a RRC connection to the RAN, and does not maintains a corresponding S1 connection to a CN. Context of the UE is only available in the CN. Mobility of the UE is controlled by the UE itself, and the RAN is unaware of a location of the UE. The CN knows a position of the UE in a granularity of a tracking area. In the RRC_IDLE state, the UE cannot send/receive user data to/from the NW directly.

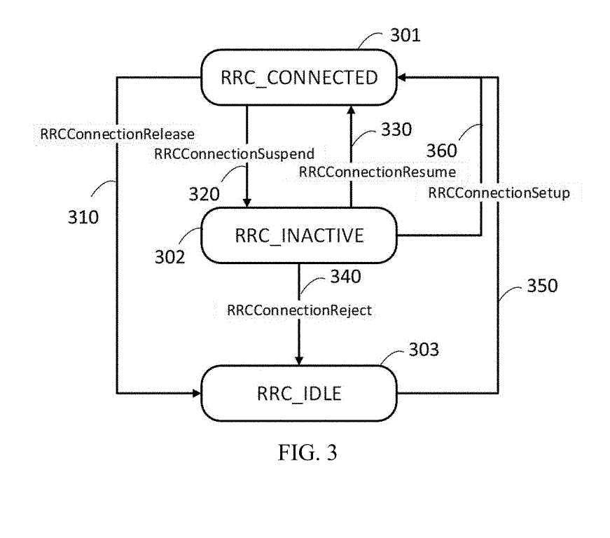

FIG. 3 illustrates schematically states of a UE and possible state transitions envisaged by inventors of the present disclosure. As shown in FIG. 3, a UE in a RRC_CONNECTED state 301 may transit (310) to a RRC_IDLE state 303 in response to a RRCConnectionRelease command from the NW, and transit (320) to a RRC_INACTIVE state 302 in response to a RRCConnectioSuspend command from the NW. A UE in a RRC_INACTIVE state 302 may transit to a RRC-CONNECTED state 301 via a RRCConnectionResume procedure 330 or a RRCConnectionSetup procedure 360, and may transit to a RRC_IDLE state 303 via a RRCConnectionReject procedure 340. In addition, a UE in a RRC_IDLE state 303 may transmit to a RRC_CONNECTED state via a RRCConnectionSetup procedure 350.

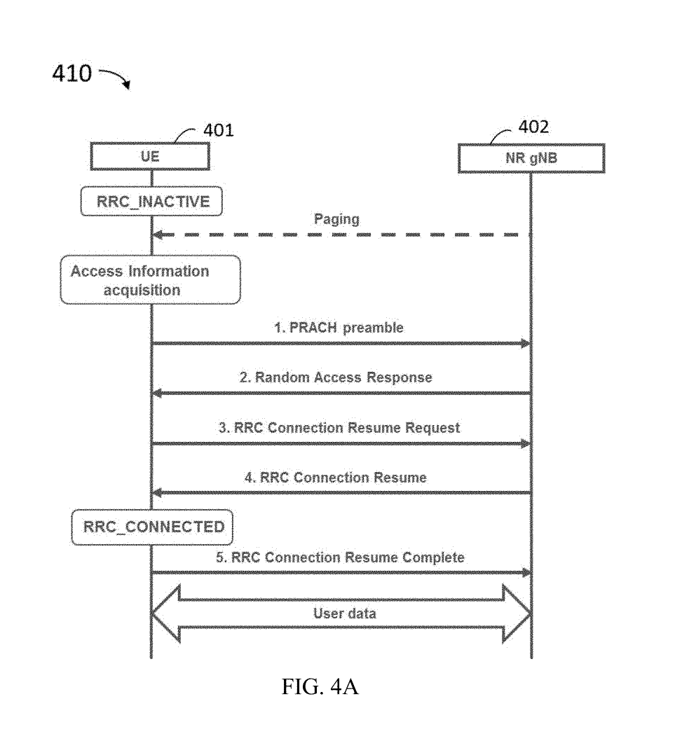

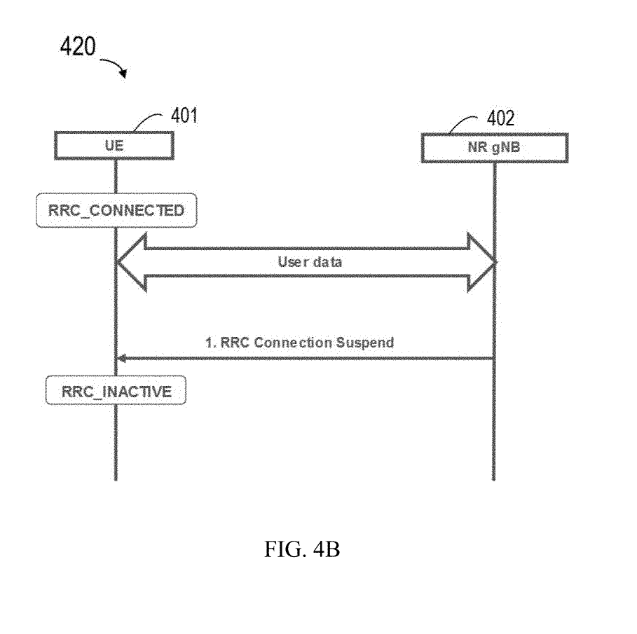

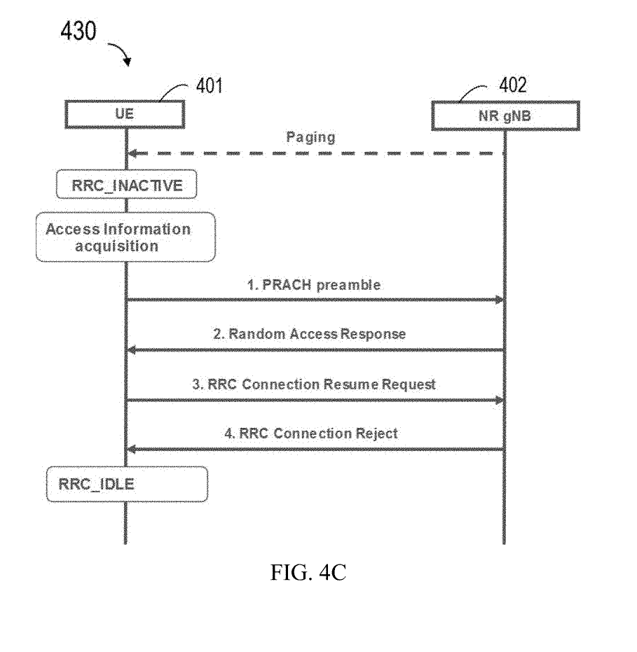

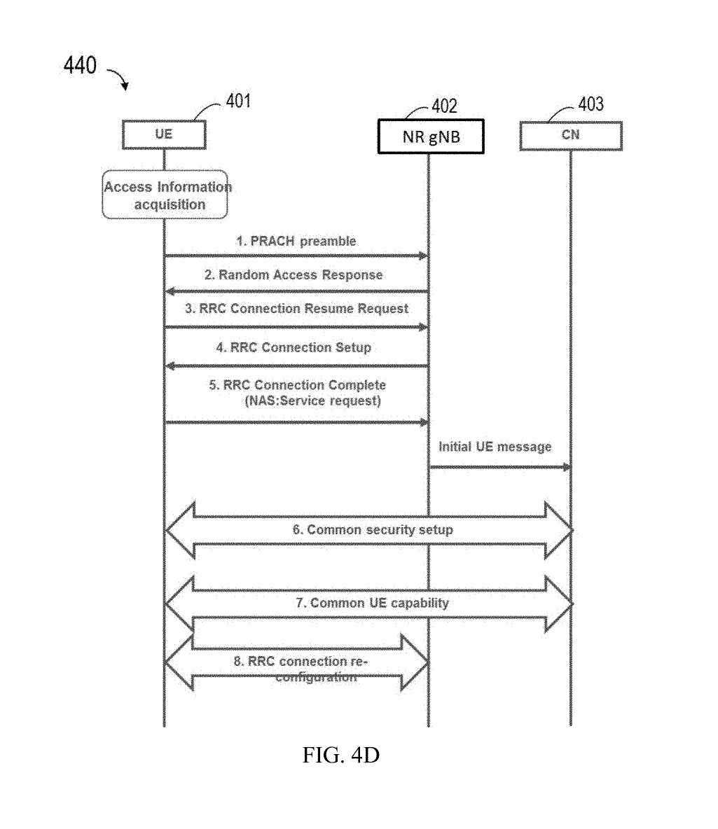

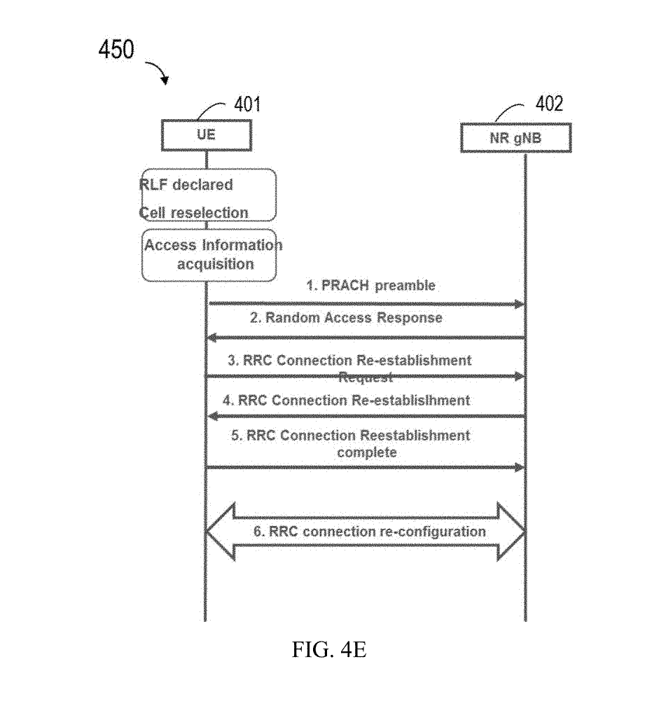

Many signaling procedures for managing a RRC connection of a UE with the RAN have been discussed in 3GPP, and some examples of which between a UE 401 and a NR gNB 402 are illustrated in FIGS. 4A-4E. FIG. 4A shows a RRC connection resume procedure 410 between the UE 401 and the NR gNB 402, FIG. 4B shows a RRC connection Suspend procedure 420, FIG. 4C shows a RRC connection Reject procedure 430, FIG. 4D shows a RRC connection Setup procedure 440 which may be triggered by RRC resume, and FIG. 4E shows a RRC connection re-establishment procedure 450. As can be observed from the signaling flows shown in FIGS. 4A-4E, the RRC connection Resume Procedure is the most efficient way for restoring a connection, since it can restore both control plane and user plane connections via a single round trip signaling exchange. The prerequisite for performing the RRC connection resume procedure may be that a network controlled RRC connection Suspend procedure is executed before the RRC connection Resume procedure. As shown in FIG. 4E, a RRC connection re-establishment procedure can be used to restore a control plane connection if UE encounters a radio link failure (RLF) which requires a following RRC connection reconfiguration procedure to restore a user plane connection. The RRC Connection Setup procedure shown in FIG. 4D is the most heavy-weight procedure which needs to be triggered where the RAN context cannot be resumed for some reason. Currently, the RRC connection Resume procedure and the RRC connection Re-establishment procedure are only considered for intra-RAT mobility.

Inventors of the present disclosure have envisaged that it will be beneficial if it would be possible to optimize signaling for a UE moving from a first RAT to a second different RAT by reusing context of the UE. For example, it may be possible to optimize signaling for UEs moving from a NR cell to a LTE cell by reusing the NG-C/U context of the UE if the UE still stays being connected to the 5G-CN.

For a UE in a RRC_CONNECTED state in the NR, this may be done by performing a network controlled handover to make the UE enter a RRC_CONNECTED state in LTE. Inventors of the present disclosure propose that the handover may be optimized so that it can be performed directly between the NR and LTE base stations by reusing NG-C/U context of the UE, and the 5G-CN only needs to be updated that the UE has moved

In addition, inventors of the present disclosure have envisaged that the network may know in which case an optimized procedure can be applied, for example, whether an optimized procedure can be used may depend on whether a target network device (for example, an LTE eNB) supports a specific CN (e.g., a 5G-CN).

Till now, no solution has been proposed to facilitate an optimization in UE controlled mobility procedures, especially for UE mobility in the following cases:
UE is in an NR cell, but loses connection due to a radio link failure and switches over to a LTE cell;
UE is in an inactive or idle state, and a cell reselection is triggered by the UE based on signals broadcasted from the NR and LTE base stations.

In order to solve at least part of the above problems, methods, apparatuses and computer programs have been proposed herein. In some embodiments, a UE moving between two cells (e.g., a NR cell and a LTE cell) is enabled to know whether it can attempt to resume or reestablish its RAN context (e.g. RRC or NG-C/U UE context) during a UE triggered connection restoration procedure. With some embodiments of the present disclosure, a connection of a UE with the RAN can be restored in a fast way, by resuming/reestablishing the RAN context rather than rebuilding the RAN context from the CN and UE stored information. Some embodiments of the present disclosure lead to shorter response time as seen by an end user. Some embodiments of the present disclosure generate less signaling in the network in case context of the UE is reused.

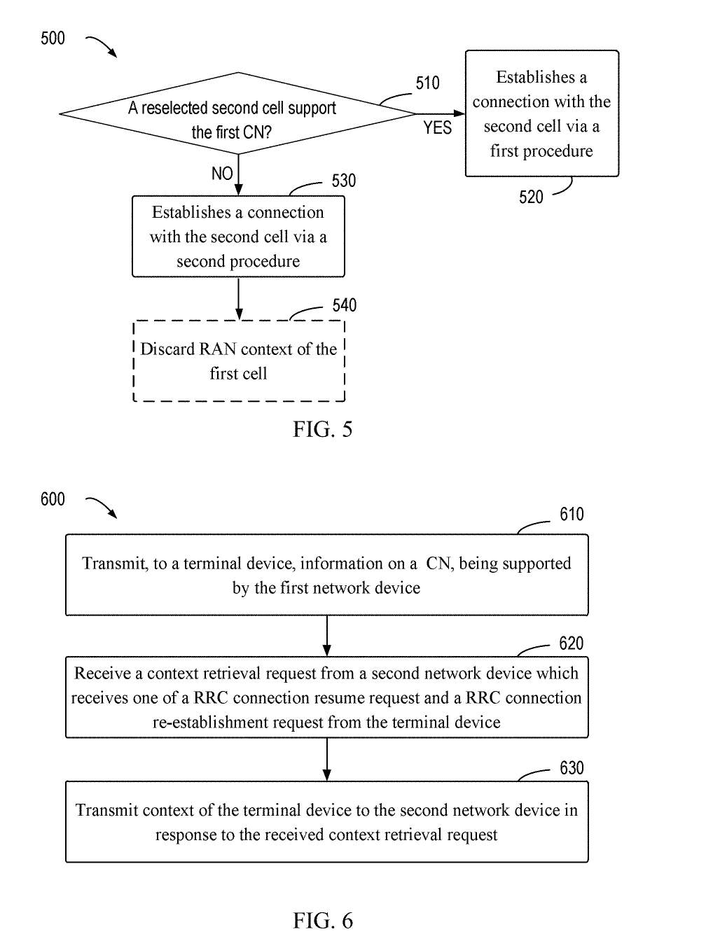

Reference is now made to FIG. 5, which shows a flowchart of a method 500 implemented in a terminal device according to an embodiment of the present disclosure. The terminal device is operating in a first cell and connected to a first core network (CN). For simplicity, the method 500 will be described below with reference to the terminal device 102 shown in FIG. 1, and in this case the first cell is the NR cell 130 covered by the gNB 101, and the first CN may be a NG CN 110 shown in FIG. 1. However, the method 500 could also be implemented by any other terminal device, for example the terminal device 103 or 104 shown in FIG. 1, or the UE 203, 213 or 223 shown in FIGS. 2A-2C. It can be appreciated that the first cell is not limited to a NR cell, but could also be a cell of any RAT, for example an LTE cell. Likewise, the first CN is not limited to a NG/5G CN, but could also be any suitable CN, for example a 4G EPC.

As illustrated in FIG. 5, at block 510, the terminal device 102 determines whether a second cell (e.g., the LTE cell 140 shown in FIG. 1) supports the first CN 110 in response to a re-selection of the second cell. In an embodiment, the terminal device 102 may be in a RRC_INACITVE state in the first cell 130, and the reselection of the second cell 140 may be due to, for example, the terminal device 102 moving out of coverage of the first cell 130 or other reasons. In another embodiment, the terminal device 102 may be in a RRC_CONNECTED state, and the reselection of the second cell 140 may be due to, for example, a radio link failure, loosing coverage of the first cell, or other reasons.

Embodiments are not limited to any specific way for determining at block 510 as to whether the second cell 140 supports the first CN 110. Just for illustration purpose, in one embodiment, the determining may be performed by the terminal device 102 by detecting information broadcasted by the second cell 140. The information may be broadcasted by the second cell 140 as system information, and in an embodiment, the information broadcasted by the second cell 140 may include at least one of: a type of the second cell, a CN (or a list of CNs) supported by the second cell, and an indication on capability of supporting the first CN. That is to say, the terminal device 102 may derive whether the second cell supports the first CN based on a type of the second cell, a list of CN(s) supported by the second cell, and/or an indication on capability of supporting the first CN.

Depending on a result of the determination at block 510, the terminal device 102 may perform operations of block 520 or block 530.

At block 520, in response to determining that the first CN is supported by the second cell 140, the terminal device 102 establishes a connection with the second cell 140 via a first procedure. In an embodiment, the first procedure may allow the second cell 140 to reuse context of the terminal device in the first cell 130 without contacting the first CN 110.

In another embodiment, the terminal device 102 may be in a RRC_INACTIVE state in the first cell 130 (e.g., a NR cell) and the first procedure may be, for example but not limited to, a RRC connection resume procedure as schematically shown in FIG. 4A. This RRC connection resume procedure allows a faster restoration of a connection with the second cell compared with a RRC connection setup procedure shown in FIG. 4D.

In some embodiments, the terminal device 102 may be in a RRC connected state and encounters a radio link failure in the first cell 130, and in this case the first procedure may be, for example, a RRC connection re-establishment procedure as schematically shown in FIG. 4E. This RRC connection re-establishment procedure also allows a faster restoration of a connection with the second cell 140 compared with a RRC connection setup procedure shown in FIG. 4D.

If the terminal device 102 determines at block 510 that the first CN 110 is not supported by the second cell 140, the operation of block 530 is performed by the terminal device 102. As shown in FIG. 5, at block 530, the terminal device 102 establishes a connection with second cell 140 via a second procedure different from the first procedure in response to determining that the first CN is non-supported by the second cell. The second procedure may not allow the second cell to reuse context of the terminal device in the first cell without contacting the first CN 110. In an embodiment, the second procedure may include a RRC connection setup procedure, for example the procedure shown in FIG. 4D. The procedure may involve more signaling overhead than a RRC connection resume procedure or a RRC connection reestablishment procedure, however, with method 500, such a procedure with heavy signaling may be avoided by the terminal device 102 based on the determination performed at block 510. As a result, the connection of the terminal device 102 may be restored in an optimized way.

In an embodiment, at block 520 or 530, the terminal device 102 may establish the connection with the second cell 140 immediately to update the RAN/network about the UE mobility upon the re-selection of the second cell 140. In another embodiment, the terminal device 102 may establish the connection with the second cell 140 later in response to uplink data arrival of the terminal device 102, or in response to receiving a paging message in the downlink from the first cell 130. That is to say, the RRC connection resume procedure, the RRC connection reestablishment procedure or the RRC connection setup procedure may be performed by the terminal device 102 when either UL data arrives or the terminal device 102 is paged in the DL.

As shown in FIG. 5, in some embodiments, the method 500 may optionally comprise a block 540. At block 540, the terminal device 102 may discard a RAN context of the first cell 130 in response to determining that the first CN is non-supported by the second cell 140.

Though some embodiments are described with reference to the terminal device 102 which may be in a NR cell 130, connected to a NG/5G CN 110 and reselect a LTE cell 140, embodiments of the present disclosure are not limited to such a scenario. In another embodiment, the terminal device may be in a LTE cell, connected to an EPC or a NG/5G CN and reselects a NR cell. In another embodiment, the first cell and the second cell may even use same RAT. It should be appreciated that embodiments of the present disclosure may be more widely applied to other scenarios where similar problem exists. For illustration rather than limitation, some scenarios to which embodiments of the present disclosure may be applied are listed below:

### Scenario 1:

A UE is in a RRC_INACTIVE state in a NR cell with stored NR RAN context, connected to a 5G CN, re-selects a LTE cell, e.g., due to loosing NR coverage, or other reasons. In this scenario, upon reselection of the LTE cell, the UE may check broadcast information of the LTE cell to determine whether the LTE cell supports a 5G-CN.

If LTE cell supports the 5G-CN, the UE may perform a RRC connection resume procedure to resume the RAN context in LTE. The resume is either performed immediately to update the RAN/network about the UE mobility or performed later when either UL data arrives or the UE is paged in the DL.

If LTE cell does not support 5G-CN, the UE may discard the RAN context and initiate a RRC connection setup procedure towards the LTE cell. The connection setup may be performed immediately to update the RAN/network about the UE mobility or performed later when either UL data arrives or the UE is paged in the DL.

### Scenario 2:

A UE is in a RRC_INACTIVE state in a LTE cell with stored LTE RAN context, connected to a 5G CN and reselects a NR cell, e.g., due to loosing LTE coverage, or other reasons. In this scenario, the UE may know from a type of the NR cell (which the UE determines based on for example information broadcasted from the NR cell) that the 5G CN is supported by the NR cell. In this case, the UE performs a RRC connection resume procedure to resume the RAN context in the NR cell. The RRC connection resume procedure may be performed immediately to update the RAN/network about the UE mobility or performed later when either UL data arrives or the UE is paged in the DL.

### Scenario 3:

A UE is in a RRC_INACTIVE state in a LTE cell with stored LTE RAN context, connected to a EPC and reselects a NR cell, e.g., due to loosing LTE coverage, or other reasons. In this scenario, the UE may know from a type of the NR cell (which the UE determines based on for example information broadcasted from the NR cell) that a 5G CN rather than an EPC is supported by the NR cell. In this case, the UE may discard the RAN context and initiate a RRC connection setup procedure towards the NR cell. The connection setup is either performed immediately to update the RAN/network about the UE mobility or it is performed later when either UL data arrives or the UE is paged in the DL.

### Scenario 4:

A UE is in a RRC_CONNECTED state in a NR cell, connected to a 5G CN, and reselects a LTE cell, e.g., due to loosing NR coverage, or other reasons. In this scenario, the UE may check broadcast information of LTE cell to determine whether the LTE cell supports the 5G-CN.

If LTE cell supports the 5G-CN, the UE may perform, for example, a RRC connection re-establishment procedure to recover the RAN context in the LTE cell. The re-establishment procedure may be performed immediately to update the RAN/network about the fact that the UE lost the NR connection.

If LTE cell does not support the 5G-CN, the UE may discard the RAN context and initiates, for example, a RRC connection setup procedure towards the LTE cell. The RRC connection setup procedure may be performed immediately to update the RAN/network about the fact that the UE lost the NR connection.

### Scenario 5:

A UE is in a RRC_CONNECTED state in a LTE cell, connected to a 5G CN, and reselects a NR cell, e.g., due to loosing LTE coverage, or other reasons. In this scenario, the UE may know from a type of the NR cell (which the UE may determine based on for example information broadcasted from the NR cell) that the 5G CN is supported by the NR cell. In this case, UE may perform a RRC connection re-establishment procedure to recover the RAN context in the NR cell. The re-establishment procedure may be performed immediately to update the RAN/network about the fact that the UE lost the LTE connection.

### Scenario 6:

A UE is in a RRC_CONNECTED state in a LTE cell, connected to an EPC, and reselects a NR cell, e.g., due to loosing LTE coverage, or other reasons. In this scenario, the UE may know from a type of the NR cell (which the UE determines based on for example information broadcasted from the NR cell) that a 5G CN rather than the EPC is supported by the NR cell. In this case, the UE may discard the RAN context and initiate a RRC connection setup procedure towards the NR cell. The connection procedure may be performed immediately to update the RAN/network about the fact that UE lost the LTE connection.

In the scenarios above, the terms of “RRC connection re-establishment” and “RRC connection resume” procedures are used. They refer to different cases. A RRC connection resume procedure may refer to a case where a UE resumes a suspended context, and a RRC connection re-establishment procedure may refer to a case where a UE re-establishes from an RLF. Though these two procedures have slightly different properties, a common feature of them is that the old RAN context (e.g., RRC, S1) is re-used. In contrast, for the RRC connection setup procedure, the RAN context is discarded and a new RAN context is built up from info stored in the CN and the UE. It can be appreciated that embodiments of the present disclosure may be applicable to other systems or use other procedures with similar properties. The term for involved procedures may vary depending on the wireless communication system to which embodiments of the present disclosure apply.

Reference is now made to FIG. 6 which shows a flowchart of a method 600 implemented in a first network device. For simplicity, the method 600 will be described below with reference to the network device 101 and the environment as described with reference to FIG. 1, however, it would be appreciated that the method 600 could also be implemented by any other network device (for example, the network device 111 shown in FIG. 1, or the network device 201, 202, 211, 212, 221 or 222 shown in FIG. 2A-2C) in any wireless communication system where similar problem exists.

As illustrated in FIG. 6, at block 610, the network device 101 transmits, to a terminal device (for example, the terminal device 102 shown in FIG. 1), information on a CN 110 being supported by the network device 101. In an embodiment, the network 101 may broadcast the information, for example, as system information. In another embodiment, the network device 101 may transmit a type of the network device 101 to the terminal device 102, the type of the network device 101 being associated with the CN 110 supported by the network device 101. For example the type of the network device 101 may indicate the CN 110 being supported implicitly. In an embodiment, a NR cell only supports a 5G CN, and then from a type of NR cell, the terminal device can know that a 5G CN is supported.

In another embodiment, the network device 101 may transmit an identity of the CN 110 to the terminal device 102. In still another embodiment, the network device 101 may transmit identities of more than one CNs to the terminal device 102. Alternatively or in addition, in some embodiments, the network device 101 may transmit its capability of supporting the CN to the terminal device 102.

In some cases, the terminal device 102 may lose connection with the network device 101 and reselects another cell, for example, the cell 140 served by the network device 111. If the reselected cell 140 supports the same CN 110, the terminal device 102 may attempt to connect to the reselected cell 140 via a RRC connection resume procedure or a RRC connection reestablishment procedure as described with reference to FIG. 500. Then the reselected cell 140 may attempt to retrieve context of the terminal device 102 from the network device 101. Accordingly, at block 620, the network device 101 receives a context retrieval request from a second network device (e.g., the network device 111 shown in FIG. 1) which receives one of a RRC connection resume request and a RRC connection re-establishment request from the terminal device 102. At block 630, the network device 101 transmits context of the terminal device 102 to the second network device 111 in response to the received context retrieval request, in order to facilitate fast connection restoration of the terminal device 102.

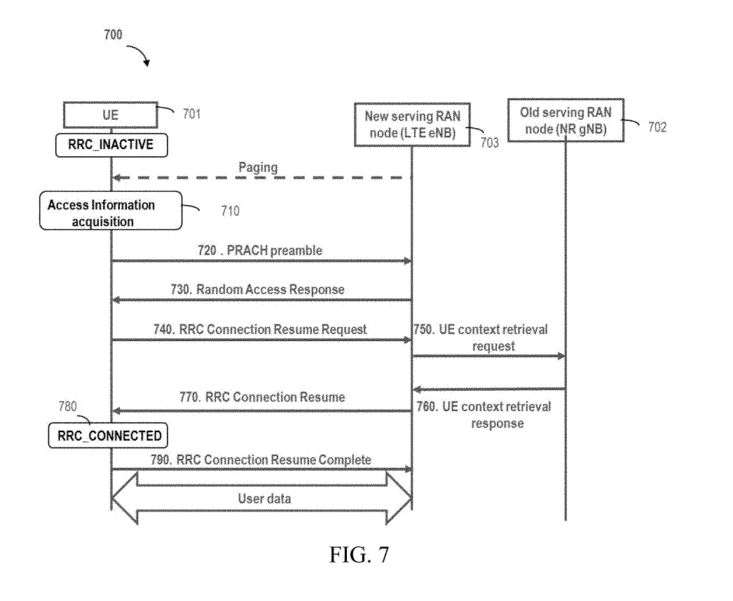

A schematic signaling flow according to an embodiment of the present disclosure is illustrated in FIG. 7. In the example shown in FIG. 7, the terminal device 701 is previously in a RRC_INACTIVE state in a cell served by network device 702 (for example, a NR BS), and reselects a cell served by the network device 703 (for example, a LTE eNB). In this example the terminal device 701 acquires 710 access related configuration and other broadcast information from the network device 703, and initiates 720 a random access procedure by transmitting a physical random access channel (PRACH) preamble to the network device 703.

In response to the PRACH preamble, the network device 703 transmits 730 a random access response (RAR) to the terminal device 701. If the terminal device 701 determines based on acquired broadcast information from the network device 703 that the network device 703 supports a 5G CN same as that served by its old serving RAN, the terminal device 701 may initiate a RRC connection resume procedure by transmitting 740 a RRC connection resume request message to the network device 703 using a resource granted in the RAR.

Then the network device 703 may send 750 a context retrieval request to the old serving node of the terminal device, i.e., the network device 702. As a response, the network device 702 may transmit 760 context of the terminal device 701 to the network device 703. Using the obtained context of the terminal device, the network device 703 transmits 770 a RRC connection resume message to the terminal device 701. Then the terminal device 701 enters 780 a RRC connected state and transmits 790 a RRC connection resume complete message to the network device 703. After that normal data communication between the terminal device 701 and the network device 703 may be performed.

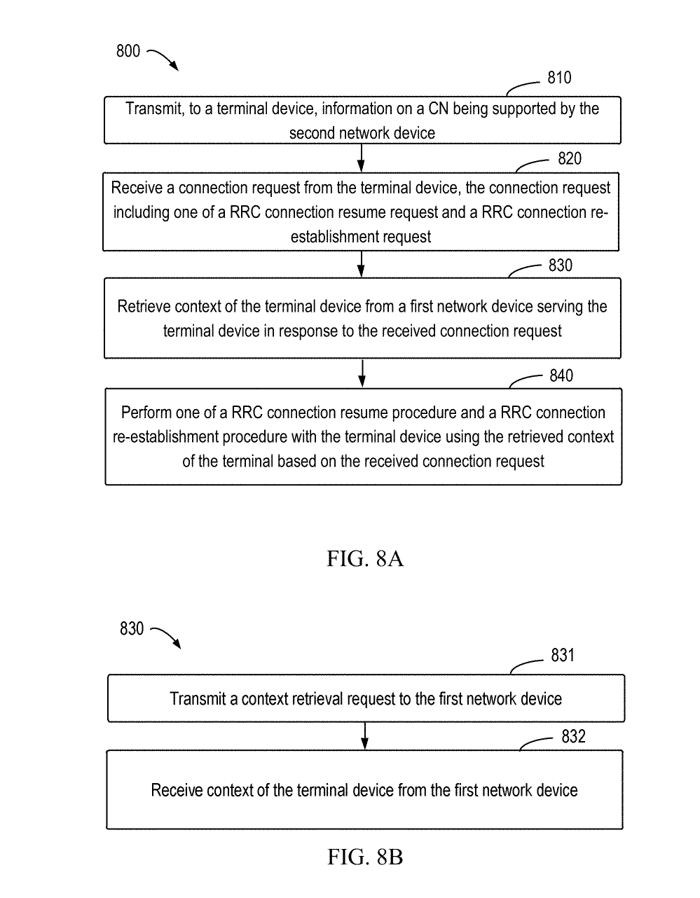

FIGS. 8A-8B illustrates flow charts of a method 800 implemented in a second network device, for example the second network device 111 shown in FIG. 1 or the network device 703 shown in FIG. 7. For ease of discussions, the method 800 will be described below with reference to the environment as described with reference to FIG. 1

As shown in FIG. 8A, at block 810, the second network device 111 transmits, to a terminal device 102 (or the terminal device 701 shown in FIG. 7), information on a CN 120, being supported by the second network device 111. In one embodiment, the information on the CN 120 may be transmitted by the second network device 111 as broadcast information, (e.g., system information). The information may indicate the supported CN 120 implicitly or explicitly. For example, at block 810, the second network device 111 may transmit a type of the second cell, an identity of the CN, and/or an indication on capability of supporting the CN to the terminal device 102.

At block 820, the second network device 111 receives a connection request from the terminal device 102. In one embodiment, the connection request may include a RRC connection resume request similar to that transmitted 740 by the terminal device 701 of FIG. 7. In another embodiment, the connection request may include a RRC connection re-establishment request as that shown in FIG. 4E.

At block 830, the second network device 111 retrieves context of the terminal device 102 from a first network device 101 (or the network device 702 shown in FIG. 7) serving the terminal device 102, in response to the received connection request. Embodiments are not limited to any specific way for retrieving context of the terminal device 102 from a first network device 101. Just for illustration, an example implementation of block 830 is shown in FIG. 8B. In the embodiment shown in FIG. 8B, the second network device 111 may retrieves context of the terminal device from the first network device 101 by performing blocks 831 and 832. At block 831, the second network device 111 transmits a context retrieval request to the first network device 101, and the signaling may be similar to that shown in 750 of FIG. 7. At block 832, the second network device 111 receives context of the terminal device 102 from the first network device 101, and the signaling may be similar to that shown in 760 of FIG. 7. It should be appreciated that in another embodiment, the second network device 111 may retrieve context of the terminal device via a procedure/signaling different from that shown in 750-760 of FIG. 7.

Now returning to FIG. 8A. Using the obtained context of the terminal device, at block 840, the second network device 111 performs one of a RRC connection resume procedure and a RRC connection re-establishment procedure with the terminal device 102. The exact procedure performed at block 840 may depend on what connection request is received from the terminal device 102 at block 820.

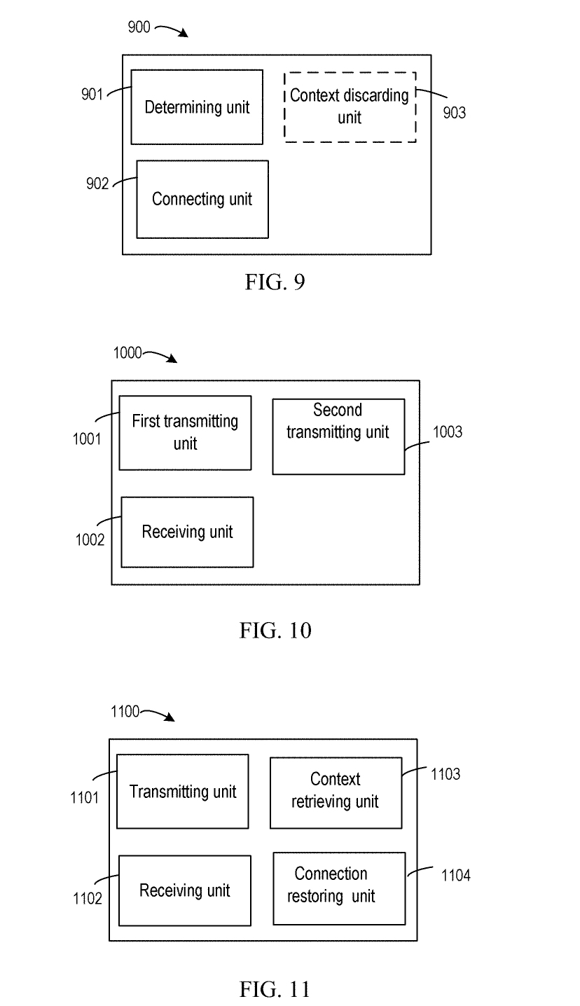

Reference is now made to FIG. 9, which illustrates a schematic block diagram of an apparatus 900 in a wireless communication network (e.g., the wireless communication network 100 shown in FIG. 1). The apparatus may be implemented as/in a terminal device, e.g., the terminal device 102 shown in FIG. 1. For ease of discussions, apparatus 900 will be described below with reference to the environment as described with reference to FIG. 1. The terminal device 102 is in a first cell (e.g., the cell 130 served by the network device 101 shown in FIG. 1) and connected to a first CN 110 (e.g., the 5G CN). The apparatus 900 is operable to carry out the example method 500 described with reference to FIG. 5 and possibly any other processes or methods. It is also to be understood that the method 500 is not necessarily carried out by the apparatus 900. At least some steps of the method 500 may be performed by one or more other entities.

As illustrated in FIG. 9, the apparatus 900 includes a determining unit 901 and a connecting unit 902. The determining unit 901 is configured to determine as to whether a second cell (e.g., the cell 140 served by the network device 111 shown in FIG. 1) supports the first CN 110 in response to a re-selection of the second cell. The connecting unit 902 is configured to establish a connection with the second cell via a first procedure in response to determining that the first CN is supported by the second cell, or establish a connection with the second cell via a second procedure different from the first procedure in response to determining that the first CN is non-supported by the second cell. In another embodiment, the apparatus 900 may further comprise a context discarding unit 903, configured to discard a RAN context of the first cell in response to determining that the first CN is non-supported by the second cell.

In one embodiment, the determining unit 901, the connecting unit 902 and the context discarding unit 903 may be configured to perform the operations of blocks 510, 520/530 and 540 of FIG. 5 respectively, and therefore descriptions provided with reference to FIG. 5 also apply here and details will not be repeated.

FIG. 10 illustrates a schematic block diagram of an apparatus 1000 in a wireless communication network (e.g., the wireless communication network 100 shown in FIG. 1). The apparatus may be implemented as/in a first network device, e.g., the network device 101 shown in FIG. 1, or the network device 702 shown in FIG. 7, or any other suitable network device. For ease of discussions, apparatus 1000 will be described below with reference to the environment as described with reference to FIG. 1. The apparatus 1000 is operable to carry out the example method 600, described with reference to FIG. 6 and possibly any other processes or methods. It is also to be understood that the method 600 is not necessarily carried out by the apparatus 1000. At least some steps of the method 600 can be performed by one or more other entities.

As illustrated in FIG. 10, the apparatus 1000 includes a first transmitting unit 1001, a receiving unit 1002 and a second transmitting unit 1003. The first transmitting unit 1001 is configured to transmit, to a terminal device 102, information on a CN being supported by the first network device 101. The receiving unit 1002 is configured to receive a context retrieval request from a second network device 111 which receives one of a RRC connection resume request and a RRC connection re-establishment request from the terminal device; and the second transmitting unit 903 is configured to transmit context of the terminal device to the second network device 111 in response to the received context retrieval request.

In one embodiment, the first transmitting unit 1001, the receiving unit 1002 and the second transmitting unit 1003 may be configured to perform operations of blocks 610-630 of FIG. 6, and therefore descriptions provided with reference to FIG. 6 and method 600 also apply here.

FIG. 11 illustrates a schematic block diagram of another apparatus 1100 in a wireless communication network (e.g., the wireless communication network 100 shown in FIG. 1). The apparatus may be implemented as/in a second network device, e.g., the network device 111 shown in FIG. 1, or the network device 703 shown in FIG. 7, or any suitable network device. For ease of discussions, apparatus 1100 will be described below with reference to the environment as described with reference to FIG. 1. The apparatus 1200 is operable to carry out the example method 800, described with reference to FIG. 8 and possibly any other processes or methods. It is also to be understood that the method 800 is not necessarily carried out by the apparatus 1100. At least some steps of the method 800 can be performed by one or more other entities.

As illustrated in FIG. 11, the apparatus 1100 includes a transmitting unit 1101, a receiving unit 1102, a context retrieving unit 1103, and a connection restoring unit 1104. The transmitting unit 1101 is configured to transmit, to a terminal device, information on a CN being supported by the second network device 111. The receiving unit 1102 is configured to receive a connection request from the terminal device, the connection request may include but not limited to one of a RRC connection resume request and a RRC connection re-establishment request. The context retrieving unit 1103 is configured to retrieve context of the terminal device from a first network device 101 serving the terminal device, in response to the received connection request; and the connection restoring unit 1104 is configured to perform one of a RRC connection resume procedure and a RRC connection re-establishment procedure with the terminal device using the retrieved context of the terminal based on the received connection request. In an embodiment, the context retrieving unit 1103 may be configured to retrieve context of the terminal device from a first network device 101 by transmitting a context retrieval request to the first network device 101, and receiving context of the terminal device from the first network device 101.

In one embodiment, the transmitting unit 1101, the receiving unit 1102, the context retrieving unit 1103, and the connection restoring unit 1104 may be configured to perform operations of blocks 810-840 of FIG. 8, and therefore descriptions provided with reference to FIG. 8 and method 800 also apply here.

Furthermore, it would be appreciated that apparatuses 900-1100 may comprise other units not shown in FIGS. 9-11. In addition, some units or modules in the apparatus 9-11 can be combined in an embodiment, or may be omitted in another embodiment. For example, in one embodiment, functions/operations of the first transmitting unit 1001 and the second transmitting unit 1003 of FIG. 10 may be performed by a single unit.

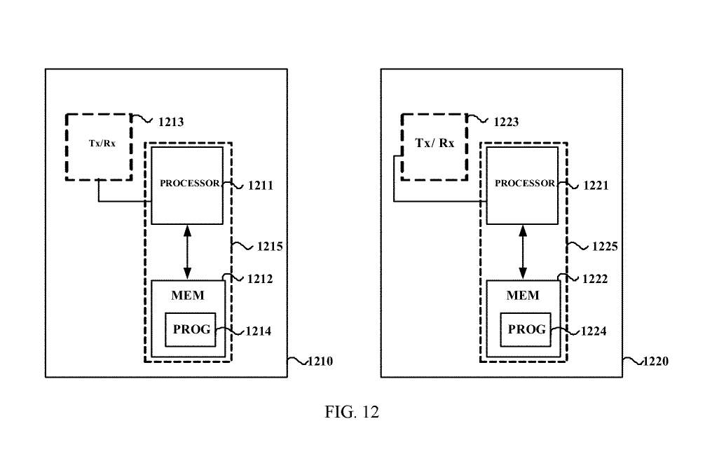

FIG. 12 illustrates a simplified block diagram of an apparatus 1210 that may be embodied in/as a terminal device, e.g., the terminal device 102, 103, or 104 shown in FIG. 1, and an apparatus 1220 that may be embodied in/as a terminal device, e.g., one of the network devices 101 and 111 shown in FIG. 1.

The apparatus 1210 may include one or more processors 1211, such as a data processor (DP) and one or more memories (MEM) 1212 coupled to the processor 1211. The apparatus 1210 may further include a transmitter TX and receiver RX 1213 coupled to the processor 1211. The MEM 1212 may be non-transitory machine readable storage medium and it may store a program (PROG) 1214. The PROG 1214 may include instructions that, when executed on the associated processor 1211, enable the apparatus 1210 to operate in accordance with the embodiments of the present disclosure, for example to perform the method 500. A combination of the one or more processors 1211 and the one or more MEMs 1212 may form processing means 1215 adapted to implement various embodiments of the present disclosure.

The apparatus 1220 includes one or more processors 1221, such as a DP, and one or more MEMs 1222 coupled to the processor 1221. The apparatus 1220 may further include a suitable TX/RX 1223 coupled to the processor 1221. The MEM 1222 may be non-transitory machine readable storage medium and it may store a PROG 1224. The PROG 1224 may include instructions that, when executed on the associated processor 1221, enable the apparatus 1220 to operate in accordance with the embodiments of the present disclosure, for example to perform the method 600 or 800. A combination of the one or more processors 1221 and the one or more MEMs 1222 may form processing means 1225 adapted to implement various embodiments of the present disclosure.

Various embodiments of the present disclosure may be implemented by computer program executable by one or more of the processors 1211 and 1221, software, firmware, hardware or in a combination thereof.

The MEMs 1212 and 1222 may be of any type suitable to the local technical environment and may be implemented using any suitable data storage technology, such as semiconductor based memory terminal devices, magnetic memory terminal devices and systems, optical memory terminal devices and systems, fixed memory and removable memory, as non-limiting examples.

The processors 1211 and 1221 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a memory containing the computer program as mentioned above, which includes machine-readable media and machine-readable transmission media. The machine-readable media may also be called computer-readable media, and may include machine-readable storage media, for example, magnetic disks, magnetic tape, optical disks, phase change memory, or an electronic memory terminal device like a random access memory (RAM), read only memory (ROM), flash memory devices, CD-ROM, DVD, Blue-ray disc and the like. The machine-readable transmission media may also be called a carrier, and may include, for example, electrical, optical, radio, acoustical or other form of propagated signals—such as carrier waves, infrared signals, and the like.

The techniques described herein may be implemented by various means so that an apparatus implementing one or more functions of a corresponding apparatus described with an embodiment includes not only prior art means, but also means for implementing the one or more functions of the corresponding apparatus described with the embodiment and it may include separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-38. (canceled)

39. A method implemented in a terminal device for cell re-selection, the terminal device being operating in a first cell and connected to a first core network (CN) the method comprising:
in response to a re-selection of a second cell, determining whether the second cell supports the first CN;
in response to determining that the first CN is supported by the second cell, establishing a connection with second cell via a first procedure; and
in response to determining that the first CN is non-supported by the second cell, establishing a connection with second cell via a second procedure different from the first procedure.

40. The method according to claim 39, wherein the first procedure allows the second cell to reuse context of the terminal device in the first cell without contacting the first CN.

41. The method according to claim 39, wherein the first procedure includes:
a Radio Resource Control (RRC) connection resume procedure, if the terminal device is in a RRC inactive state in the first cell; or
a RRC connection re-establishment procedure, if the terminal device is in a RRC connected state and encounters a radio link failure in the first cell.

42. The method according to claim 39, wherein the second procedure includes a RRC connection setup procedure.

43. The method according to claim 39, wherein determining whether the second cell support the first CN comprises:
determining whether the second cell supports the first CN by detecting information broadcasted by the second cell.

44. The method according to claim 43, wherein the information broadcasted by the second cell includes at least one of:
a type of the second cell;
a CN supported by the second cell; and
an indication on capability of supporting the first CN.

45. The method according to claim 39, wherein the first CN includes one of:
an evolved packet core network (EPC) and
a fifth generation core network (5G CN).

46. The method according to claim 39, wherein:
the first cell includes a next radio (NR) cell; and
the second cell includes a long term evolution (LTE) cell.

47. The method according to claim 39, wherein:
the first cell includes a long term evolution (LTE) cell; and
the second cell includes a next radio (NR) cell.

48. The method according to claim 39, wherein establishing the connection with the second cell comprises one of:
establishing the connection with the second cell upon the re-selection of the second cell;
establishing the connection with the second cell in response to uplink data arrival of the terminal device; and
establishing the connection with the second cell in response to receiving a paging message in the downlink from the first cell.

49. The method according to claim 39, further comprising:
discarding a radio access network (RAN) context of the first cell in response to determining that the first CN is non-supported by the second cell.

50. A method implemented in a first network device, comprising:
transmitting, to a terminal device, information on a core network (CN) being supported by the first network device;
receiving a context retrieval request from a second network device which receives one of a radio resource control (RRC) connection resume request and a RRC connection re-establishment request from the terminal device; and
transmitting context of the terminal device to the second network device in response to the received context retrieval request.

51. The method according to claim 50, wherein transmitting to the terminal device information on the CN being supported by the first network device comprises transmitting at least one of the following to the terminal device:
a type of the first network device, the type of the first network device being associated with the CN;
an identity of the CN; and
an indication on capability of supporting the CN.

52. A method implemented in a second network device, comprising:
transmitting, to a terminal device, information on a core network (CN) being supported by the second network device;
receiving a connection request from the terminal device, the connection request including one of a radio resource control (RRC) connection resume request and a RRC connection re-establishment request;
retrieving context of the terminal device from a first network device serving the terminal device in response to the received connection request; and
performing one of a RRC connection resume procedure and a RRC connection re-establishment procedure with the terminal device using the retrieved context of the terminal device based on the received connection request.

53. The method according to claim 52, wherein transmitting to the terminal device information on the CN being supported by the second network device comprises transmitting at least one of the following to the terminal device:
a type of the second network device, the type of the second network device being associated with the CN;
an identity of the CN; and
an indication on capability of supporting the CN.

54. The method according to claim 52, wherein retrieving context of the terminal device from the first network device comprises:
transmitting a context retrieval request to the first network device; and
receiving context of the terminal device from the first network device.

55. An apparatus in a terminal device operating in a first cell and connected to a first core network (CN), the apparatus comprising a processor and a memory, said memory containing instructions executable by said processor whereby said apparatus is operative to:
in response to a re-selection of a second cell, determine whether the second cell supports the first CN;
in response to determining that the first CN is supported by the second cell, establish a connection with second cell via a first procedure; and
in response to determining that the first CN is non-supported by the second cell, establish a connection with second cell via a second procedure different from the first procedure.

56. The apparatus according to claim 55, wherein the first procedure allows the second cell to reuse context of the terminal device in the first cell without contacting the first CN.

57. The apparatus according to claim 55, wherein the first procedure includes:
a RRC connection resume procedure, if the terminal device is in a RRC inactive state in the first cell; or
a RRC connection re-establishment procedure, if the terminal device is in a RRC connected state and encounters a radio link failure in the first cell.

58. The apparatus according to claim 55, wherein the second procedure includes a RRC connection setup procedure.

59. The apparatus according to claim 55, wherein said memory contains instructions executable by said processor whereby said apparatus is further operative to determine whether the second cell support the first CN by detecting information broadcasted by the second cell.

60. The apparatus according to claim 59, wherein the information broadcasted by the second cell includes at least one of:
a type of the second cell;
a CN supported by the second cell; and
an indication on capability of supporting the first CN.

61. The apparatus according to claim 55, wherein the first CN includes one of:
an evolved packet core network (EPC); and
a fifth generation core network (5G CN).

62. The apparatus according to claim 55, wherein:
the first cell includes a next radio (NR) cell; and
the second cell includes a long term evolution (LTE) cell.

63. The apparatus according to claim 55, wherein:
the first cell includes a long term evolution (LTE) cell; and
the second cell includes a next radio (NR) cell.

64. The apparatus according to claim 55, wherein said memory contains instructions executable by said processor whereby said apparatus is further operative to establish a connection with the second cell by one of:
establishing the connection with the second cell upon the re-selection of the second cell;
establishing the connection with the second cell in response to uplink data arrival of the terminal device; and
establishing the connection with the second cell in response to receiving a paging message in the downlink from the first cell.

65. The apparatus according to claim 55, wherein said memory contains instructions executable by said processor whereby said apparatus is further operative to:
discard a radio access network (RAN) context of the first cell in response to determining that the first CN is non-supported by the second cell.

66. An apparatus in a first network device, the apparatus comprising a processor and a memory, said memory containing instructions executable by said processor whereby said apparatus is operative to:
transmit, to a terminal device, information on a core network (CN) being supported by the first network device;
receive a context retrieval request from a second network device which receives one of a radio resource control (RRC) connection resume request and a RRC connection re-establishment request from the terminal device; and
transmit context of the terminal device to the second network device in response to the received context retrieval request.

67. The apparatus according to claim 66, wherein said memory contains instructions executable by said processor whereby said apparatus is further operative to transmit to the terminal device information on the CN being supported by the first network device by transmitting at least one of the following to the terminal device:
a type of the first network device, the type of the first network device being associated with the CN;
an identity of the CN; and
an indication on capability of supporting the CN.

68. An apparatus in a second network device, the apparatus comprising a processor and a memory, said memory containing instructions executable by said processor whereby said apparatus is operative to:
transmit, to a terminal device, information on a core network (CN) being supported by the second network device;
receive a connection request from the terminal device, the connection request including one of a radio resource control (RRC) connection resume request and a RRC connection re-establishment request;
retrieve context of the terminal device from a first network device serving the terminal device in response to the received connection request; and
perform one of a RRC connection resume procedure and a RRC connection re-establishment procedure with the terminal device using the retrieved context of the terminal based on the received connection request.

69. The apparatus according to claim 68, wherein said memory contains instructions executable by said processor whereby said apparatus is further operative to transmit to the terminal device information on the CN being supported by the second network device by transmitting at least one of the following to the terminal device:
a type of the second network device, the type of the second network device being associated with the CN;
an identity of the CN; and
an indication on capability of supporting the CN.

70. The apparatus according to claim 68, wherein said memory contains instructions executable by said processor whereby said apparatus is further operative to retrieve context of the terminal device from the first network device by:
transmitting a context retrieval request to the first network device; and
receiving context of the terminal device from the first network device.

71. A non-transitory, computer-readable medium storing computer-executable instructions that, when executed on at least one processor, configure a terminal device to carry out the method according to claim 39.

72. A non-transitory, computer-readable medium storing computer-executable instructions that, when executed on at least one processor, configure a first network device to carry out the method according to claim 50.

73. A non-transitory, computer-readable medium storing computer-executable instructions that, when executed on at least one processor, configure a second network device to carry out the method according to claim 52.
